(19) United States
(12) Patent Application Publication
(10) Pub. No.: US 2026/0260541 A1
(43) Pub. Date: Sep. 3, 2026

(54) GAMING MACHINES HAVING CRYPTOCURRENCY MINING FUNCTIONALITY AND METHODS OF USE

(71) Applicant: Shawn Driscoll, Temecula, CA (US)

(72) Inventor: Shawn Driscoll, Temecula, CA (US)

(21) Appl. No.: 19/068,772

(22) Filed: Mar. 3, 2025

(51) Int. Cl. G07F 17/32; G06Q 20/36; H05K 7/20

(52) U.S. Cl. CPC G07F 17/3251; G06Q 20/3678; G07F 17/3209; G07F 17/3216; H05K 7/20136; H05K 7/20209; G06Q 2220/00

(57) ABSTRACT

Systems and methods for using a cryptocurrency mining-enabled gaming machine system are provided. The cryptocurrency mining-enabled gaming machine system may comprise a cryptocurrency mining portion, configured to perform cryptocurrency mining to mine one or more cryptocurrency units, the cryptocurrency mining portion comprising one or more cryptocurrency mining modules, and a gaming console portion, configured to run a game programming, the gaming console portion comprising a display, a graphical user interface, and a computing device comprising a processor and a memory. The cryptocurrency mining portion and the gaming console portion may be both configured to be powered by a singular power source.

### BACKGROUND

### Technical Field

Embodiments of the present disclosure relate to gaming machines and cryptocurrency mining systems and, in particular, to gaming machines having cryptocurrency mining functionality and methods of use.

### BACKGROUND

Gaming machines, such as slot machines, video poker machines, video roulette machines, and other suitable gaming machines incorporate lights, sounds, processors, memories, displays, speakers, user interfaces, and/or other components configured to enable a user to play a game (e.g., a game wherein the user may win one or more prizes) and provide entertainment. These gaming machines run on electricity to perform their many functions, and many perform tasks (e.g., controlling the displays, lights, speakers, etc.) when not in use by a user. For example, gaming machines may play sounds or music, perform light shows, and display pictures or video on their displays in order to entice users to play.

While gaming machines have been designed and programmed to perform many entertainment-type and gaming-type functions, they have not been designed to perform cryptocurrency mining. Cryptocurrency mining is generally performed by specialized computers have specialized software and hardware configured to solve cryptographic puzzles to digitally mine and find cryptocurrencies while establishing blockchain proof of work (POW) verification.

### SUMMARY

According to an object of the present disclosure, a system is provided. The system may comprise a cryptocurrency mining portion, configured to perform cryptocurrency mining to mine one or more cryptocurrency units, the cryptocurrency mining portion comprising one or more cryptocurrency mining modules, and a gaming console portion, configured to run a game programming, the gaming console portion comprising a display, a graphical user interface, and a computing device comprising a processor and a memory. The cryptocurrency mining portion and the gaming console portion may be both configured to be powered by a singular power source.

According to an exemplary embodiment, the memory of the computing device may be configured to store instructions that, when executed by the processor, are configured to cause the processor to: receive a command from a user to start a game; run the game programming; and calculate a prize.

According to an exemplary embodiment, the calculating the prize may comprise calculating some or all of the cryptocurrency units mined by the cryptocurrency mining portion as the prize or a portion of the prize.

According to an exemplary embodiment, each of the one or more cryptocurrency mining modules may comprise a processor and a memory.

According to an exemplary embodiment, the memory of each of the one or more cryptocurrency mining modules may be configured to store instructions that, when executed by the processor, are configured to cause the processor to solve one or more cryptographic puzzles.

According to an exemplary embodiment, the cryptocurrency mining portion and the gaming console portion may be configured to run simultaneously.

According to an exemplary embodiment, the system may comprise one or more fans and one or more thermostats configured to measure a temperature of one or more components of the system.

According to an exemplary embodiment, the one or more fans may be configured to run when the temperature exceeds a threshold temperature.

According to an exemplary embodiment, the graphical user interface may comprise one or more of the following: a lever; a button; and a touch screen.

According to an exemplary embodiment, the system may be configured to couple to one or more other similar systems, in series.

According to an object of the present disclosure, a method for using a cryptocurrency mining-enabled gaming machine system is provided. The method may comprise initializing the cryptocurrency mining-enabled gaming machine system. The cryptocurrency mining-enabled gaming machine system may comprise a cryptocurrency mining portion, configured to perform cryptocurrency mining to mine one or more cryptocurrency units, the cryptocurrency mining portion comprising one or more cryptocurrency mining modules, and a gaming console portion, configured to run a game programming, the gaming console portion comprising a display, a graphical user interface, and a computing device comprising a processor and a memory. The cryptocurrency mining portion and the gaming console portion may be both configured to be powered by a singular power source. The method may comprise simultaneously executing a game, using the gaming console portion, and activating a cryptocurrency mining mode, using the cryptocurrency mining portion. The activating the cryptocurrency mining mode may comprise mining for cryptocurrency.

According to an exemplary embodiment, the initializing the cryptocurrency mining-enabled gaming machine system may comprise inserting payment into the cryptocurrency mining-enabled gaming machine system.

According to an exemplary embodiment, the executing the game may comprise performing one or more gaming tasks based on one or more rules of the game.

According to an exemplary embodiment, the executing the game may comprise determining whether any winning conditions have been met.

According to an exemplary embodiment, the method may comprise, when winning conditions have been met, determining one or more rewards to be distributed to a user.

According to an exemplary embodiment, the one or more rewards may comprise some or all of the cryptocurrency mined using the cryptocurrency mining-enabled gaming machine system.

According to an exemplary embodiment, the method may comprise distributing the one or more rewards to the user.

According to an exemplary embodiment, the activating the cryptocurrency mining mode may comprise saving, into a digital wallet, cryptocurrency mined using the cryptocurrency mining-enabled gaming machine system.

According to an exemplary embodiment, the method may comprise fluctuating a cryptocurrency mining power used during cryptocurrency mining.

According to an exemplary embodiment, the cryptocurrency mining power may be fluctuated based on a state of gameplay of the game.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a side view of a cryptocurrency mining-enabled gaming machine system, according to an exemplary embodiment of the present disclosure.

FIG. 2 illustrates a front schematic view of a cryptocurrency mining portion of the system of FIG. 1, according to an exemplary embodiment of the present disclosure.

FIG. 3 illustrates a side view of a cryptocurrency mining-enabled gaming machine system, according to an exemplary embodiment of the present disclosure.

FIG. 4 illustrates a front schematic view of a cryptocurrency mining portion of the system of FIG. 1, according to an exemplary embodiment of the present disclosure.

FIG. 5 illustrates a perspective view of a cryptocurrency mining-enabled gaming machine system, according to an exemplary embodiment of the present disclosure.

FIG. 6 illustrates a perspective view of a cryptocurrency mining-enabled gaming machine system, according to an exemplary embodiment of the present disclosure.

FIG. 7 illustrates a flowchart of a method for mining cryptocurrency and performing one or more gaming functions using a cryptocurrency mining-enabled gaming machine system, according to an exemplary embodiment of the present disclosure.

FIG. 8 illustrates example elements of a computing device, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to exemplary embodiments, systems and methods for cryptocurrency mining-enabled gaming machine systems and methods for use are provided.

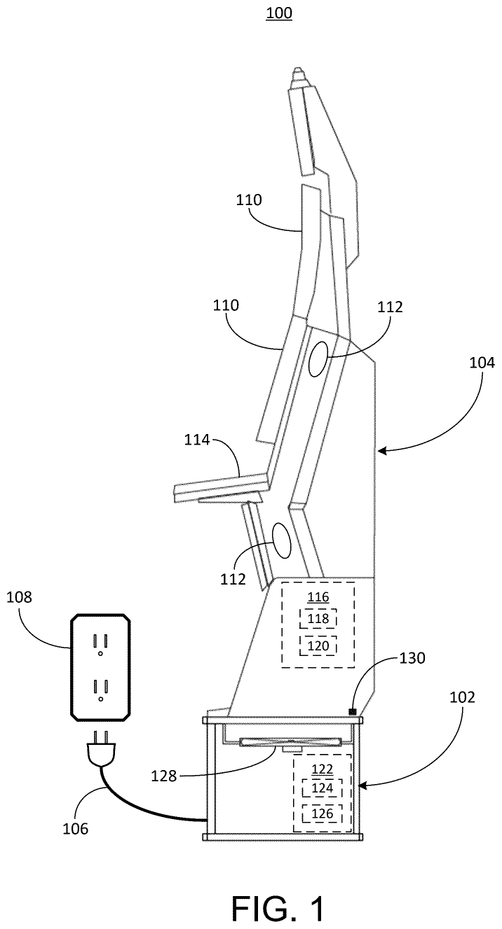

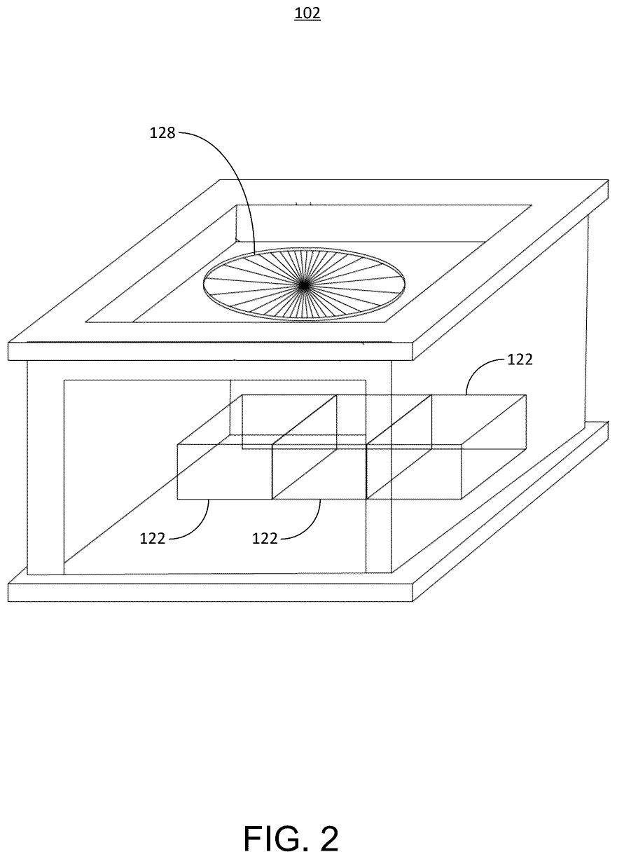

Referring now to FIGS. 1-2, a side view of a cryptocurrency mining-enabled gaming machine system 100 (FIG. 1) and a perspective view of a cryptocurrency mining portion 102 of the cryptocurrency mining-enabled gaming machine system 100 (FIG. 2), in accordance with an exemplary embodiment of the present disclosure.

Traditional slot machines operate solely on fiat or digital transactions, while cryptocurrency mining requires dedicated computational resources. The system 100 may be configured to merge both functions, utilizing gaming infrastructure to contribute to blockchain mining while enhancing player rewards.

According to an exemplary embodiment, the system 100 may be configured to combine cryptocurrency mining operations with slot machine gameplay, allowing for a seamless process whereby cryptocurrency mining may occur in the background while one or more players engage in slot games (or other suitable game types). According to an exemplary embodiment, the mined cryptocurrency may be utilized for jackpot funding.

According to an exemplary embodiment, the system 100 may comprise a cryptocurrency mining portion 102 and a gaming console portion 104. According to an exemplary embodiment, the system 100 may comprise a plug or other electrical connector 106 coupled to a power source 108 configured to enable power to be transferred to the system 100. The plug or other electrical connector 104 may be configured to transfer power to both the cryptocurrency mining portion 102 and the gaming console portion 104.

According to an exemplary embodiment, the gaming console portion 104 may comprise one or more displays 110, speakers 112, user interfaces 114, and one or more computing devices 116. The one or more computing devices 116 may comprise one or more processors 118 and one or more memories 120. The one or more memories 120 may be configured to store instructions that, when executed by the one or more processors 118 may be configured to cause the one or more processors 118 to perform one or more tasks. The one or more tasks may comprise displaying one or more lights and/or sounds, receiving payment from a user, receiving game selection from the user (e.g., selecting a game type, a wager type, a wager amount, etc.), receiving a command from the user to start a game, running a game program, calculating a prize, awarding the prize, and/or other suitable tasks. According to an exemplary embodiment, the running the game may comprise randomizing one or more outcomes of the game in accordance with a random number generator and/or other randomization means.

According to an exemplary embodiment, the cryptocurrency mining portion 102 may comprise one or more cryptocurrency mining modules 122. The one or more cryptocurrency mining modules 122 may comprise one or more processors 124 and memories 126. The one or more memories 126 may be configured to store instructions that, when executed by the one or more processors 124 may be configured to cause the one or more processors 124 to perform one or more tasks. The one or more tasks may comprise performing cryptocurrency mining comprising solving one or more cryptographic puzzles to digitally mine and find cryptocurrencies while establishing blockchain proof of work (POW) verification. It is noted, however, that the one or more cryptocurrency mining modules 122 may be configured to performing cryptocurrency mining through one or more other suitable means, while maintaining the spirit and functionality of the present disclosure.

According to an exemplary embodiment, the one or more processors 124 may be cryptocurrency mining algorithm processors configured to use cryptographic hashing (e.g., SHA-256 cryptographic hashing) and/or other suitable means of mining cryptocurrency. According to an exemplary embodiment, the processor 124 may be configured to run in the background while one or more slot machine processes are executed by computing device 116. According to an exemplary embodiment, the one or more cryptocurrency mining modules 122 may be configured to adjust power consumption dynamically for the system 100 based on game activity.

According to an exemplary embodiment, the system 100 may be configured to run the cryptocurrency mining portion 102 and the gaming console portion 104 simultaneously using the singular power source 108, through the plug or other electrical connector 106, to power both the cryptocurrency mining portion 102 and the gaming console portion 104.

According to an exemplary embodiment, the one or more cryptocurrency mining modules 122 may be configured to communicate with the one or more computing devices 116 of the gaming console portion 104. The one or more cryptocurrency mining modules 122 may be configured to cause one or more pictures, words, sounds, and/or other media to be displayed and/or projected through the one or more displays 110 and/or one or more speakers 112. According to an exemplary embodiment, the one or more computing devices 116 of the gaming console portion 104 may be configured to access one or more cryptocurrency units mined by the one or more cryptocurrency mining modules 122 and/or provide some or all of the cryptocurrency units mined by the one or more cryptocurrency mining modules 122 as prizes. According to an exemplary embodiment, real-time cryptocurrency mining statistics and/or rewards may be configured to be displayed using the one or more displays 110.

According to an exemplary embodiment, the one or more computing devices 116 may be configured to perform one or more smart payout functions whereby players may be rewarded with one or more cryptocurrency amounts (or fractional cryptocurrency amounts) based on one or more factors. The one or more factors may comprise an amount of time spent playing, a total mining power contributed, game winnings (e.g. slot winnings), game multipliers, and/or other suitable factors. According to an exemplary embodiment, the one or more computing devices 116 may be configured to payout any cryptocurrency winnings and/or use some or all of the cryptocurrency winnings for one or more gaming credits.

According to an exemplary embodiment, the one or more computing devices 116 of the gaming console 104 may be configured to run on one or more servers separate and apart from the one or more servers one which the one or more cryptocurrency mining modules 122 run.

According to an exemplary embodiment, the system 100 may be configured to act as a partial node in a cryptocurrency network, communicating with a blockchain for real-time mining and transaction verification. This ensures security through decentralized validation.

According to an exemplary embodiment, one or more components of the system 100 may be configured to establish a gaming and financial ledger, recording transactions, wins, losses, and cryptocurrency mining contributions. This ledger may be configured to securely track player activity for regulatory compliance and/or may be configured to support crypto-wallet integration.

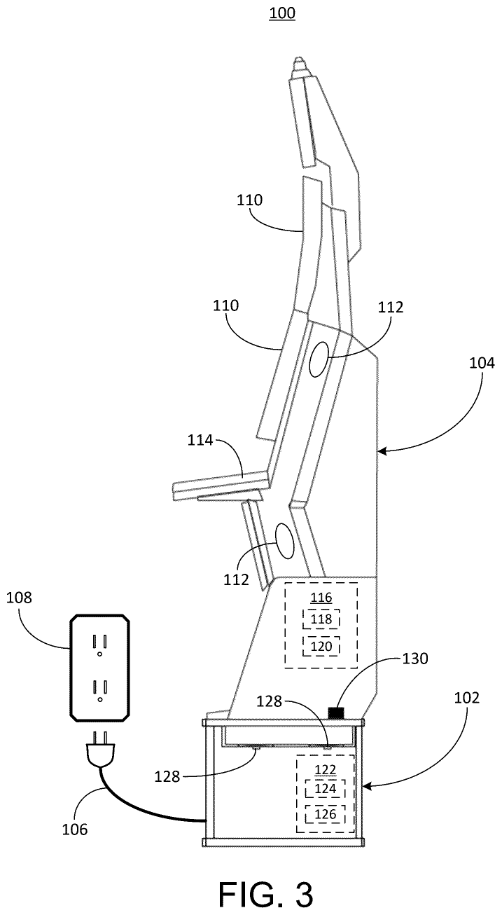

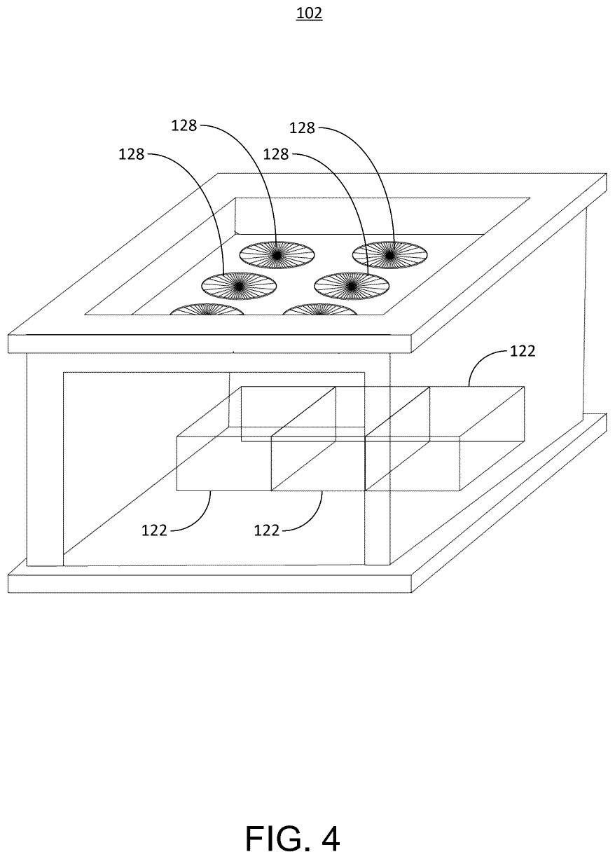

According to an exemplary embodiment, the system 100 may comprise one or more fans 128 configured to cool one or more components of the cryptocurrency mining portion 102 and/or the gaming console portion 104. As shown in FIGS. 1-2 the system 100 may comprise a single fan 128 or, as shown, e.g., in FIGS. 3-4, the system 100 may comprise a plurality of fans 128. According to an exemplary embodiment, the system 100 may comprise one or more thermostats 130 configured to measure a temperature of the system 100 and/or one or more components of the system 100. The one or more fans 128 may be coupled to, and configured to be controlled by, the one or more cryptocurrency mining modules 122, the one or more computing devices 116 of the gaming console portion 104, and/or by one or more other suitable devices/systems. The one or more fans 128 may be configured to run when the temperature of the system 100 and/or one or more components of the system exceeds a threshold temperature. The one or more fans 128 may be configured to be powered by the power source 108, through the plug or other electrical connector 106.

According to an exemplary embodiment, computing device 116 may function as a cryptocurrency mining module 122, controlling both the cryptocurrency mining portion 102 and the gaming console portion 104. In such an embodiment, the system 100 may or may not comprise a separate cryptocurrency mining module 122.

According to an exemplary embodiment, cryptocurrency mining module 122 may function as computing device 116, controlling both the cryptocurrency mining portion 102 and the gaming console portion 104. In such an embodiment, the system 100 may or may not comprise a separate computing device 116.

According to an exemplary embodiment, the cryptocurrency mining module 122 and/or the computing device 116 may comprise or be in electronic communication with an integrated cryptocurrency mining chip (e.g., an application-specific integrated circuit (ASIC)), a graphics processing unit (GPU) cluster, and/or other suitable components.

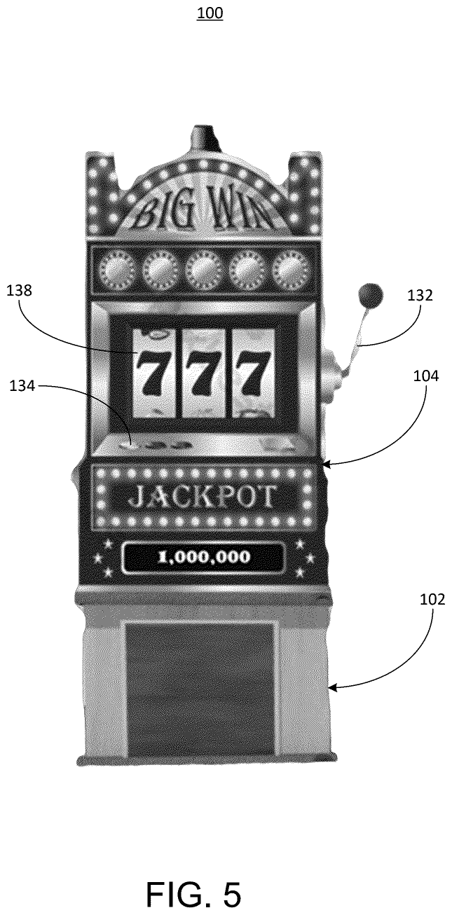

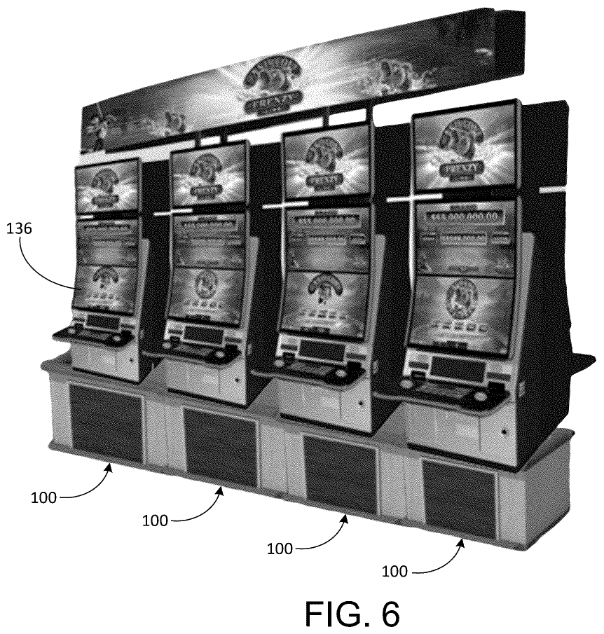

According to an exemplary embodiment, the user interface 114 may comprise one or more handles/levers 132 (as shown, e.g., in FIG. 5), buttons 134 (as shown, e.g., in FIG. 5), touch screens 136 (as shown, e.g., in FIG. 6), reels 138 (as shown, e.g., in FIG. 5), and/or other suitable type of user display and/or interface.

According to an exemplary embodiment, the system 100 may comprise a standalone system 100 (as shown, e.g., in FIG. 5), and/or a series of systems 100 (as shown, e.g., in FIG. 6). According to an exemplary embodiment, each system 100 in the series of systems 100 may be electrically isolated from the other systems 100 or electrically joined with the other systems 100.

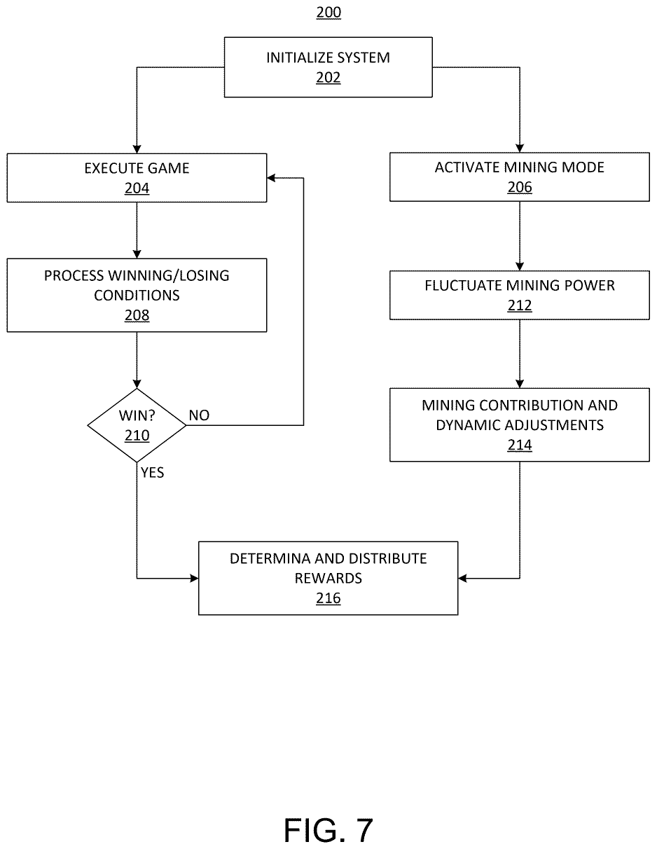

Referring now to FIG. 7, a method 200 for using a cryptocurrency mining-enabled gaming machine system is illustratively depicted, in accordance with an exemplary embodiment of the present disclosure.

At 202, the cryptocurrency mining-enabled gaming machine system may be initialized. Initializing the system may comprise powering on the system, inserting and/or receiving payment (e.g., fiat currency, a loyalty card, and/or other suitable forms of payment) into the system, and/or activating a cryptocurrency mining mode, allocating computing power to cryptocurrency mining.

According to an exemplary embodiment, once the system is initialized, the system may simultaneously execute a game (e.g., a slot game, video poker game, and/or other suitable game), at 204, and activate a cryptocurrency mining mode, at 206.

According to an exemplary embodiment, executing the game may comprise performing one or more gaming tasks based on one or more rules of the game. For example, when the game is a slot machine game, executing the game may comprise selecting a game and performing a spin. When the game is a video poker game, executing the game may comprise taking one or more bets, dealing the cards, and performing one or more other related tasks. Based on the rules of the game, the system may process any winning or losing conditions, at 208, to determine, at 210, whether any winning conditions have been met. If no winning conditions have been met, then, at 204, the system may execute the game.

When winning conditions have been met, then, at 216, one or more rewards may be determined and distributed.

Simultaneously with executing the game, the system may activate the cryptocurrency mining mode, at 206. According to an exemplary embodiment, activating the cryptocurrency mining mode may comprise solving one or more cryptographic puzzles to digitally mine and find cryptocurrencies while establishing blockchain POW verification. It is noted, however, that one or more other suitable means of cryptocurrency mining may be incorporated while maintaining the spirit and functionality of the present disclosure. According to an exemplary embodiment, some or all of the cryptocurrency mined using the system may be stored in a digital wallet until such time that the cryptocurrency is transferred (e.g., as prizes for gameplay).

At 212, mining power may be fluctuated. According to an exemplary embodiment, mining power fluctuations may be based on one or more factors. These one or more factors may comprise the type of gameplay being performed for the game (e.g., during active gameplay, a full mining power mode may be active when the game is idle and a reduced mining power mode may be active during high-intensity gaming actions), the system's internal thermal control system (e.g., mining power may be diminished when the temperature of the system and/or one or more components of the system is above a threshold to prevent overheating), one or more user-indicated power consumption policies, and/or other suitable factors. According to an exemplary embodiment, the system may be configured to automatically detect idle periods in order to maximum mining activity while auto-regulating energy consumption to optimize profitability.

At 214, one or mining contributions may be determined and/or executed and one or more dynamic adjustments may be made. For example, dynamic hash rate allocation (DHRA) and/or other suitable means may be used to balance power between cryptocurrency mining and gaming functions.

When winning conditions have been met, then, at 216, one or more rewards may be determined and distributed. According to an exemplary embodiment, determining and distributing the rewards may comprise determining whether all or a portion of the cryptocurrency mined using the system is to be awarded as prizes for game play. When all or a portion of the cryptocurrency mined using the system is to be awarded as prizes for game play, a set amount of cryptocurrency mined using the system may be distributed as prizes to the user (alone or in addition to any other prizes determined during gameplay). According to an exemplary embodiment, cryptocurrency may be awarded digitally, may be converted into other currency (e.g., government-issued currency), and/or may be offered to be exchanged for one or more gaming credits.

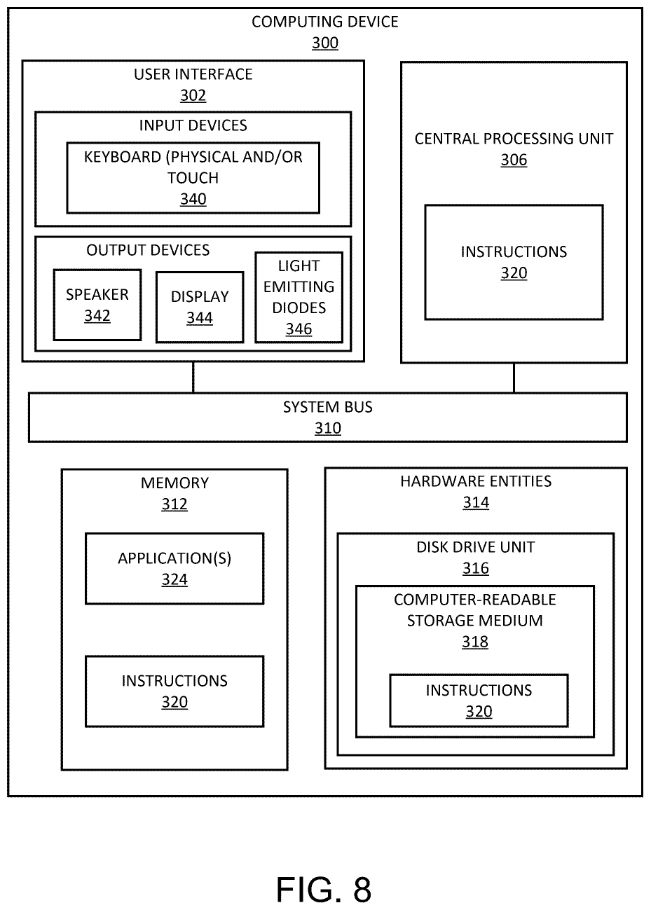

Referring now to FIG. 8, an illustration of an example architecture for a computing device 300 is provided. According to an exemplary embodiment, one or more functions of the present disclosure may be implemented by a computing device such as, e.g., computing device 300 or a computing device similar to computing device 300. Computing device 300 may be a quantum computer, a classical computer, and/or have one or more components configured to perform one or more quantum and/or classical computing functions. Computing device 116 or cryptocurrency mining module 122 may be an example of computing device 300 and/or may comprise one or more components of computing device 300.

The hardware architecture of FIG. 8 represents one example implementation of a representative computing device configured to implement at least a portion of the systems/devices (e.g., system 100) and method(s)/control logic(s) (e.g., method 200) described herein.

Some or all components of the computing device 300 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 8, the computing device 300 may comprise a user interface 302 (e.g., a graphical user interface), a Central Processing Unit (“CPU”) 306, a system bus 310, a memory 312 connected to and accessible by other portions of computing device 300 through system bus 310, and hardware entities 314 connected to system bus 310. The user interface may comprise input devices and output devices, which may be configured to facilitate user-software interactions for controlling operations of the computing device 300. The input devices may comprise, but are not limited to, a physical and/or touch keyboard 340. The input devices may be connected to the computing device 300 via a wired or wireless connection (e.g., a Bluetooth® connection). The output devices may comprise, but are not limited to, a speaker 342, a display 344, and/or light emitting diodes 346.

At least some of the hardware entities 314 may be configured to perform actions involving access to and use of memory 312, which may be a Random Access Memory (RAM), a disk driver and/or a Compact Disc Read Only Memory (CD-ROM), among other suitable memory types. Hardware entities 314 may comprise a disk drive unit 316 comprising a computer-readable storage medium 318 on which may be stored one or more sets of instructions 320 (e.g., programming instructions such as, but not limited to, software code) configured to implement one or more of the methodologies, procedures, or functions described herein. The instructions 320 may also reside, completely or at least partially, within the memory 312 and/or within the CPU 306 during execution thereof by the computing device 300.

The memory 312 and the CPU 306 may also constitute machine-readable media. The term “machine-readable media”, as used here, refers to a single medium or multiple media (e.g., a centralized or distributed database, and/or associated caches and servers) that store the one or more sets of instructions 320. The term “machine-readable media”, as used here, also refers to any medium that is capable of storing, encoding, or carrying a set of instructions 320 for execution by the computing device 300 and that cause the computing device 300 to perform any one or more of the methodologies of the present disclosure. According to various embodiments, one or more computer applications 324 may be stored on the memory 312.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A system, comprising:
a cryptocurrency mining portion, configured to perform cryptocurrency mining to mine one or more cryptocurrency units, the cryptocurrency mining portion comprising one or more cryptocurrency mining modules; and
a gaming console portion, configured to run a game programming, the gaming console portion comprising:
a display;
a graphical user interface; and
a computing device comprising a processor and a memory,
wherein the cryptocurrency mining portion and the gaming console portion are both configured to be powered by a singular power source.

2. The system of claim 1, wherein the memory of the computing device is configured to store instructions that, when executed by the processor, are configured to cause the processor to:
receive a command from a user to start a game;
run the game programming; and
calculate a prize.

3. The system of claim 2, wherein the calculating the prize comprises calculating some or all of the cryptocurrency units mined by the cryptocurrency mining portion as the prize or a portion of the prize.

4. The system of claim 1, wherein each of the one or more cryptocurrency mining modules comprises a processor and a memory.

5. The system of claim 4, wherein the memory of each of the one or more cryptocurrency mining modules is configured to store instructions that, when executed by the processor, are configured to cause the processor to solve one or more cryptographic puzzles.

6. The system of claim 1, wherein the cryptocurrency mining portion and the gaming console portion are configured to run simultaneously.

7. The system of claim 1, further comprising:
one or more fans; and
one or more thermostats configured to measure a temperature of one or more components of the system.

8. The system of claim 7, wherein the one or more fans are configured to run when the temperature exceeds a threshold temperature.

9. The system of claim 1, wherein the graphical user interface comprises one or more of the following:
a lever;
a button; and
a touch screen.

10. The system of claim 1, wherein the system is configured to couple to one or more other similar systems, in series.

11. A method for using a cryptocurrency mining-enabled gaming machine system, the method comprising:
initializing the cryptocurrency mining-enabled gaming machine system, wherein the cryptocurrency mining-enabled gaming machine system comprises:
a cryptocurrency mining portion, configured to perform cryptocurrency mining to mine one or more cryptocurrency units, the cryptocurrency mining portion comprising one or more cryptocurrency mining modules; and
a gaming console portion, configured to run a game programming, the gaming console portion comprising:
a display;
a graphical user interface; and
a computing device comprising a processor and a memory,
wherein the cryptocurrency mining portion and the gaming console portion are both configured to be powered by a singular power source; and
simultaneously executing a game, using the gaming console portion, and activating a cryptocurrency mining mode, using the cryptocurrency mining portion,
wherein the activating the cryptocurrency mining mode comprises mining for cryptocurrency.

12. The method of claim 11, wherein the initializing the cryptocurrency mining-enabled gaming machine system comprises inserting payment into the cryptocurrency mining-enabled gaming machine system.

13. The method of claim 11, wherein the executing the game comprises performing one or more gaming tasks based on one or more rules of the game.

14. The method of claim 11, wherein the executing the game comprises determining whether any winning conditions have been met.

15. The method of claim 14, further comprising, when winning conditions have been met, determining one or more rewards to be distributed to a user.

16. The method of claim 15, wherein the one or more rewards comprise some or all of the cryptocurrency mined using the cryptocurrency mining-enabled gaming machine system.

17. The method of claim 15, further comprising distributing the one or more rewards to the user.

18. The method of claim 11, wherein the activating the cryptocurrency mining mode comprises saving, into a digital wallet, cryptocurrency mined using the cryptocurrency mining-enabled gaming machine system.

19. The method of claim 11, further comprising fluctuating a cryptocurrency mining power used during cryptocurrency mining.

20. The method of claim 19, wherein the cryptocurrency mining power is fluctuated based on a state of gameplay of the game.
